(19) United States
(12) Patent Application Publication
(10) Pub. No.: US 2007/0062932 A1
(43) Pub. Date: Mar. 22, 2007

(54) System and method for heating massage oils and the like

(76) Inventor: Atanu Saha, New York, NY (US)

Correspondence Address: OSTROLENK FABER GERB & SOFFEN, 1180 AVENUE OF THE AMERICAS, NEW YORK, NY, 100368403, US

(21) Appl. No.: 11/219,616

(22) Filed: Sep. 2, 2005

(51) Int. Cl. H05B 3/06

(52) U.S. Cl. 219/521

(57) ABSTRACT

A system for heating substances like oils, lotions, waxes, and gels, includes a container and a separate base unit with at least one heating element. The container with the substance therein is placed onto the base unit to heat the substance. The container is then removed from the base unit to dispense the substance. The container may include a heat conductive surface(s), like metal, to heat the substance more efficiently. The base unit may include a pressure switch connected to the heating element. The switch is configured such that placing the container on the base unit moves the switch to an on position, turning on the heating element, and removing the container moves the switch to an off position, turning off the heating element. The system may further include a glove that receives the container with a heated substance. The glove insulates the container helping to retain heat and making the container easier to handle.

### BACKGROUND OF THE INVENTION

1. Field of the Invention

The present invention relates to a system for heating substances like massage oils, lotions, gels, and waxes, and in particular, relates to a system that includes a heater and a separate container for heating and dispensing such substances.

2. Description of the Art

Portable systems for heating massage oils, lotions, and body gels, for example, are well known. For example, in U.S. Pat. No. 6,437,295 to Hogg et al., there is disclosed a portable lotion and massage oil heating system. This system includes a container for holding and dispensing the lotion or massage oil and further includes a separate base unit with a heating element and corresponding thermostat control. In use, lotion, for example, is placed into the container and the container is placed into the base unit where the lotion is heated through the heating element. Once the lotion reaches a desired temperature, the container is removed from the base unit and taken to a desired location where the heated lotion is dispensed. Similarly, Ideal Products sells portable bottle warmers for heating and dispensing gels and lotions (see, e.g., www.idealproducts.com/GW108.htm). Similar to the system disclosed in the U.S. Pat. No. 6,437,295 patent, a bottle with a gel or lotion is placed into a base unit, the gel or lotion is heated, and the bottle is thereafter removed in order to dispense the heated gel or lotion.

These prior portable systems for heating lotions, oils, gels, and the like, however, have several drawbacks. For example, prior heating systems may not efficiently conduct heat from the base unit (i.e., heating element) to the container contents. Notably, the system disclosed in the U.S. Pat. No. 6,437,295 patent, for example, addresses this issue by placing water into the base unit and then submerging the container into the water. In this way, the water is used as a conductor to warm the container contents more effectively. Unfortunately, the use of the water can be messy, especially when removing the container to dispense the container contents.

Another problem with prior portable heating systems is that once the container is removed from the base unit and taken to a desired location, the heat of the container contents dissipates through the container walls. As such, the container must be constantly reinserted into the base unit so as to reheat and maintain the container contents at a desired temperature. Unfortunately, this frequent reheating can be inconvenient.

A similar problem with prior portable heating systems is that once the container is removed from the base unit, the container may be hot. As a result, the container may be difficult to handle and may also cause injuries.

Some prior heating systems include on/off switches that require a user to manually turn the base unit on and off. Unfortunately, such on/off arrangements can be inefficient and inconvenient. For example, each time the container is removed from the base unit, the base continues to heat and consume power unless the user manually shuts the unit off. However, this constant turning on and off of the base unit each time the container is inserted and removed can be inconvenient. In addition, upon inserting the container into the base, the user may forget to turn the base unit on.

### SUMMARY

Accordingly, it is desirable to provide a system for heating massage oils and the like that overcomes the above and other disadvantages of the prior art. According to an example embodiment of the invention, a massage oil heater includes a container and a separate base unit that houses at least one heating element. Massage oil, for example, is placed into the container and the container is then seated into the base unit, for example, where the heating element heats or warms the massage oil. Once the massage oil is heated, the container is removed from the base unit and taken to a desired location where the massage oil is dispensed. Between subsequent uses thereafter, the container may be placed on a table, for example, or may be placed back into the base unit where the massage oil is continuously heated. Notably, the massage oil heater of the present invention is not limited to heating/warming only massage oils and is also suitable for heating other substances, such as body oils, body lotions, massage lotions, body waxes, body gels, medical gels, and the like.

According to an example embodiment of the invention, the container may form an enclosed chamber for holding the massage oil. The container may include an opening with a removable cap, for example, for filling the chamber and may further include a spout, for example, for dispensing the massage oil from the chamber. Nonetheless, the container is not limited to this form and may include, for example, a single opening for both filling the chamber with massage oil and for dispensing the oil therefrom. Alternatively, the container may include a single opening with a corresponding removable cap with a spout, for example. Here, the cap is removed to fill the chamber with massage oil. Thereafter, the cap is placed back onto the container and the massage oil is dispensed through the spout. The spout may include, for example, a nozzle that can be closed. The container may also include a handle for carrying and/or dispensing the massage oil.

According to another example embodiment of the invention, rather than forming an enclosed chamber, the container may have an open topside, for example, thereby forming an open dish that exposes the chamber and the massage oil therein. Again, the container may also include a handle for carrying and/or dispensing the massage oil.

The container may be formed from any suitable material known in the art such as plastic, metal, glass, wood, etc. or some combination thereof. According to an example embodiment of the invention, one or more portions of the container are made of a heat conductive material, such as a metal like aluminum, iron, steel, copper, or an alloy thereof. According to one aspect of the present invention, the heat conductive portions of the container lie adjacent to and possibly contact the heating element when the container is placed into the base unit. In this way, heat is more efficiently transferred from the heating element to the massage oil within the container. For example, the bottom of the container, or portions or surfaces thereof, may be made of a heat conductive material.

According to another aspect of the present invention, portions of the container beyond those areas that lie adjacent to the heating element when the container is placed into the base unit are also formed of a heat conductive material. In this way, the heat from the heating element disperses over larger areas of the container, thereby more evenly heating the massage oil therein.

As for the base unit, according to an example embodiment of the invention this unit is separate from the container and houses at least one heating element, as indicated above. In general, the base unit may have any suitable shape and may be, for example, a single platform on which the container is placed, or be an open chamber into which the container is placed, for example.

The heating element may be a resistance-type electrical heating element as is known in the art, although any type of heating element may be used. When the heating element is a resistance-type electrical heating element, the base unit may further include a power input mechanism in order to transfer power from a power source to the heating element. For example, standard electrical power from an outlet may power the heating element. In this case, the base unit may further include a standard power cord in electrical connection to the heating element. Alternatively or in addition, power from one or more batteries may power the heating element. In this case, the base unit may further include a battery chamber in electrical connection with the heating element and for receiving one or more batteries. Nonetheless, the heating element may be powered from any suitable source and the base unit may thereby include any suitable power input mechanism.

According to another example embodiment of the invention, the base unit may also include a heat conductive plate that is disposed over the heating element such that the plate contacts the heating element, for example. Alternatively, the heating element may be embedded within the plate. The plate may be made of metal, for example, such as aluminum, iron, steel, copper, or an alloy thereof. In this way, the plate conducts the heat from the heating element and assists in dispersing the heat. According to an example embodiment of the invention, when the container is placed into the base unit, the container may rest upon and contact the plate. Alternatively, the container may reside at a spaced distance above the plate.

According to a further aspect of the invention, the heat conductive plate may extend beyond the heating element such that when the container is placed into the base unit, the plate contacts/lies adjacent to increased areas of the container. In this way, the heat from the heating element disperses over larger areas of the container, thereby more evenly heating the massage oil therein.

According to the present invention, a specific size and location of the heating element within the base unit is not required. For example, the heating element may be situated along the bottom of the base unit. If the base unit is formed as an open chamber, the heating element may alternatively or additionally be situated along the inner sidewall of the base unit. Again, a heat conductive plate may also reside over the heating element or extend beyond the heating element, as described above.

According to another example embodiment of the invention, the base unit does not include a heat conductive plate, thereby possibly exposing the heating element. In this configuration, the container with massage oil may either contact the heating element when placed into the base unit or may reside at a spaced distance above the heating element, as similarly described above.

According to an example embodiment of the invention, the base unit may further include, for example, a thermostat in electrical connection with the heating element. This thermostat may be selected and/or configured to maintain a pre-selected constant heating temperature for the heating element, thereby heating the massage oil within the container to this pre-selected temperature, for example. Alternatively, the thermostat may further include a thermostat control that allows a user to adjust the operating temperature of the thermostat to a desired temperature.

According to an example embodiment of the invention, the heating element may automatically begin heating as soon as the base unit receives power. Alternatively, the base unit may further include an on/off switch, such as a toggle switch or switch integrated with the thermostat control, for example, that allows a user to manually turn the heating element on and off.

According to another example embodiment of the invention, the base unit may include an on/off switch in the form of a pressure switch that is in electrical connection with the heating element. This pressure switch may be configured, for example, such that while pressure is applied to the switch, power is supplied to the heating element and such that when the pressure is removed from the switch, the power is shut-off from the heating element. Nonetheless, the pressure switch may have any suitable form.

According to a further example embodiment of the invention, the pressure switch is configured on the base unit such that when the container is inserted into the base unit, the container causes the pressure switch to move to an on position (e.g., forms an electrical connection) by applying pressure to the switch, for example. Similarly, when the container is removed from the base unit, the container causes the pressure switch to move to an off position (e.g., breaks the electrical connection) by removing the applied pressure, for example. As such, through the pressure switch, when the container is placed into the base unit, the heating element automatically turns on, thereby heating the massage oil within the container. Similarly, when the container is removed from the base unit, the heating element automatically turns off.

The present invention is not limited to a pressure on-off switch as just described. Specifically, any switch known in the art that is configurable to move between on and off positions through the placing and removing of the container to and from the base unit may be used.

According to another example embodiment of the invention, the base unit may include both a pressure switch, or the like, and also an on/off switch, such as a toggle switch or a switch integral with the thermostat control. Here, the pressure switch may operate, for example, only when the on/off switch is in the on position. As another example, the on/off switch may allow the heating element to be turned on regardless of whether the pressure switch is in the on position.

According to a further example embodiment of the invention, the massage oil heater further includes a carrying glove for the container. Specifically, once the massage oil within the container is heated and the container is removed from the base unit as described above, the container may be placed into the carrying glove, which covers one or more surfaces/walls of the container. The glove-encased container may then be moved to a desired location. Notably, the carrying glove and possibly the container may include a locking mechanism for securing the carrying glove to the container.

Preferably, the carrying glove is made of material that does not conduct heat. In this way, the carrying glove may serve several purposes. Specifically, the carrying glove may insulate the container, keeping the heated massage oil warm, and may also allow user to lift and handle the container without touching any hot surfaces.

When the massage oil within the container needs to be reheated, such as when additional oil is added to the container, the carrying glove may be removed from the container and the container then placed into the base unit, as described above.

As such, according to one aspect of the present invention, the carrying glove acts as a heat buffer, allowing a user to easily grasp the container without being affected by the heat of the container. According to another aspect of the present invention, the carrying glove alternatively or additionally also acts as an insulation layer for the container, trapping the heat within the container and helping to keep the massage oil warm.

In general, the carrying glove can be formed from any suitable material known in the art that will buffer heat from a user's touch and/or that will trap heat dissipating from the container once the container is inserted into the glove. Accordingly, the carrying glove may be formed from any non-heat-conductive material known in the art. Notably, the carrying glove may be formed from a flexible material, such as cloth, fabric, or leather, for example, or from a rigid material, such as plastic, for example. Notably, when portions of the container are made from a heat-conductive material, like metal, the carrying glove preferably covers these portions.

Other features and advantages of the present invention will become apparent from the following description of the invention, which refers to the accompanying drawings.

### BRIEF DESCRIPTION OF THE DRAWINGS

FIG. 1 shows a side plan view of an example massage oil heater including a container and separate base unit, according to the present invention.

FIG. 2 shows a top plan view of the example container shown by FIG. 1.

FIG. 3 shows a top plan view of the example base unit shown by FIG. 1.

FIG. 4 shows a cross-sectional view of the example base unit shown by FIG. 3.

FIG. 5A shows a side plan view of an example carrying glove according to the present invention, and further shows the insertion of an example container into the carrying glove.

FIG. 5B shows a cross-sectional view of the example carrying glove shown by FIG. 5A.

FIG. 5C shows a top plan view of the example container shown by FIG. 1 inserted into the example carrying glove shown by FIG. 5A.

FIG. 5D shows a top plan view of an example interlocking mechanism for retaining a container within a carrying glove according to the present invention, the carrying glove being partially cut away.

FIGS. 5E and 5F show a top plan view of the example interlocking mechanism shown by FIG. 5D and the interaction of this interlocking mechanism with an example container.

### DESCRIPTION OF THE EMBODIMENTS

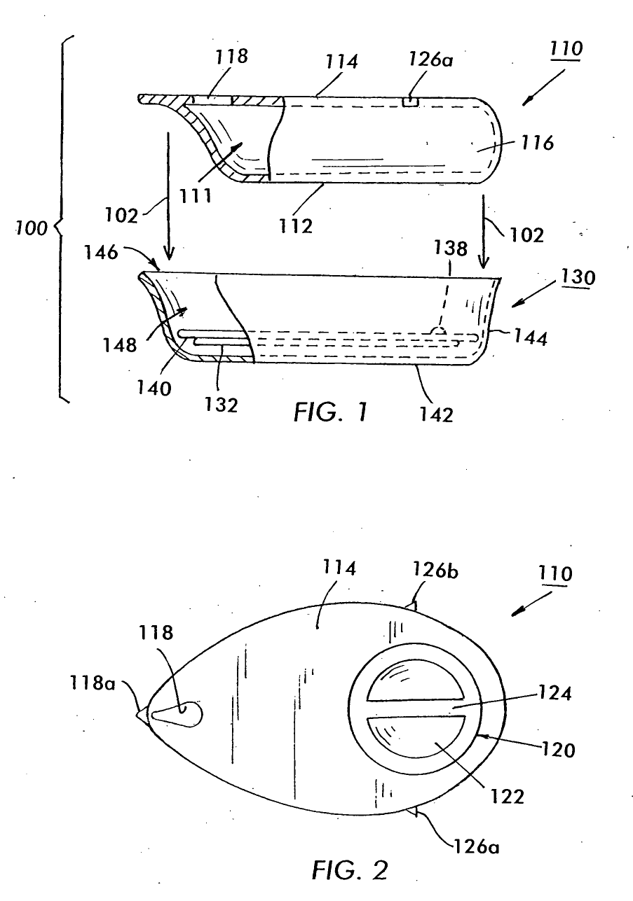

Referring to FIG. 1, there is illustrated an example massage oil heater 100 according to an example embodiment of the invention. In general, note that the present invention will be described as a heater for heating or warming “massage oils.” Nonetheless, the present invention is not limited to massage oils and is also suitable for heating other substances such as body oils, body lotions, massage lotions, body waxes, body gels, medical gels, and the like. Accordingly, the term “massage oil” will be used herein to generically and collectively refer to all such substances. As illustrated, massage oil heater 100 includes a container 110 and a separate base unit 130 that houses at least one heating element 132. In general, massage oil is placed into container 110 and the container is then seated into base unit 130 over heating element 132, for example, as illustrated by arrows 102 (alternatively, massage oil may be placed into container 130 while the container is in base unit 130). Once container 110 is situated in base unit 130, heating element 132 heats or warms the massage oil within the container. Once the massage oil is heated, container 110 is removed from base unit 130 and taken to a desired location, for example, where the massage oil is dispensed. Notably, while massage oil is not being dispensed from container 110, the container may be placed on a surface such as a table, for example, or alternatively, may be placed back into base unit 130 where the massage oil is continuously heated, for example.

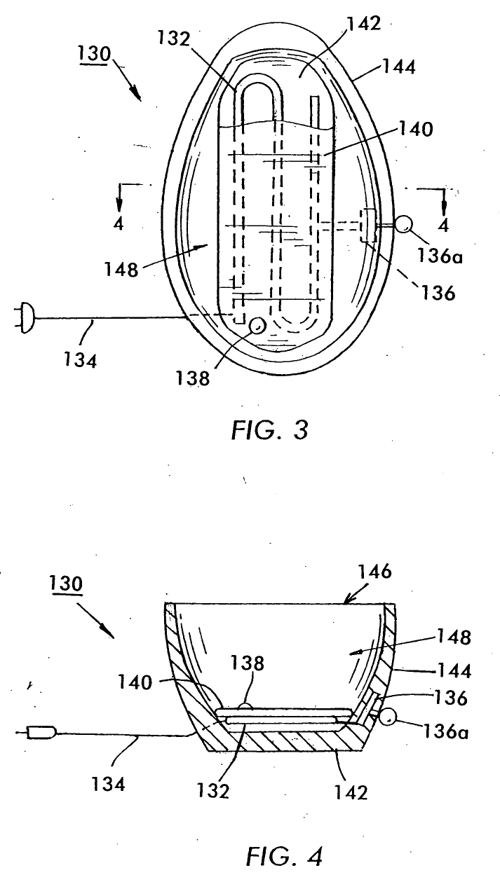

Reference will now be made in greater detail to container 110 and base unit 130. Beginning with container 110 and referring to FIGS. 1 and 2, according to an example embodiment of the invention, container 110 forms an enclosed chamber 111 through, for example, an interconnected bottom wall 112, top wall 114, and sidewall 116. Nonetheless, one skilled in the art will recognize that any combination of interconnected wall or walls may be used to form enclosed chamber 111. In general, massage oil is placed into chamber 111, heated/warmed therein, and thereafter dispensed from the chamber.

Container 110 is preferably sized such that the container is portable, although the container may have any suitable size. Preferably, container 110 is substantially flat along bottom wall 112, thereby allowing container 110 to be placed securely on a surface such as a table, for example, when not in use. Nonetheless, one skilled in the art will recognize that the bottom wall does not need to be flat. In addition, the container may have any suitable shape, such as, for example, a tear-drop like shape as shown in FIGS. 1 and 2, although this shape is not required.

Referring to FIG. 2, a spout 118 and opening 120 are situated within top wall 114, for example, of container 110. Opening 120 provides access to chamber 111 in order to fill the chamber with massage oil and spout 118 provides a mechanism for dispensing massage oil from the chamber once the oil is heated, for example. Beginning with opening 120, this opening preferably has a corresponding removable cap 122, although cap 122 is not required. As an example, cap 122 may be a plug made of plastic or rubber, for example, that snuggly fits within opening 120, thereby sealing chamber 111. Opening 120 and cap 122 may also each be threaded such that the cap screws into the opening. Nonetheless, any mechanism known in the art for providing a removable cap that seals chamber 111 can be used. In addition, note that opening 120 and cap 122 do not need to be situated in the top wall 114 of the container and may be situated at any suitable location on container 110, such as in sidewall 116. As is readily understood, by removing cap 122, chamber 111 of container 110 can be initially filled with massage oil and thereafter resealed.

As for spout 118, as indicated, this spout provides a mechanism for dispensing massage oil from chamber 111, such as by tilting container 110, for example, towards the spout. Accordingly, spout 118 is preferably sized such that massage oil is dispensed from container 110 in a controlled manner. In addition, spout 118 is preferably shaped, such as in a tear-drop-like shape, such that the massage oil easily pours from container 110 in a non-drop-like fashion. To assist with this pouring, spout 118 may also include a lip 118a. In general, note that spout 118 does not need to be situated in top wall 114 of container 110 and may be situated at any suitable location on container 110, such as in sidewall 116.

Notably, container 110 is not limited to opening 120/cap 122 and spout 118 in order to fill chamber 111 with massage oil and to dispense the oil therefrom and any mechanism known in the art for filling and dispensing massage oil may be used. For example, container 110 does not need to include opening 120. Here, for example, spout 118 may be used to both add massage oil to chamber 111 and to also dispense the massage oil therefrom. As another example, container 110 may have a single opening with a corresponding removable cap with a spout. Here, the cap is removed to fill chamber 111 with massage oil. Thereafter, the cap is re-inserted back over the opening and the massage oil is dispensed from chamber 111 through the spout. As a further example, the spout may include a nozzle that can be closed, for example. Here, the container may be a squeeze bottle, for example, the squeezing of which forces the massage oil through the nozzle.

As further illustrated in FIG. 2, container 110 may also include a handle 124 for grasping container 110 and for dispensing massage oil therefrom. As illustrated in FIG. 2, handle 124 may be molded into cap 122, for example. Nonetheless, handle 124 may have any suitable location and may be situated anywhere on container 110 including along top wall 114 and/or sidewall 116, for example. Furthermore, one skilled in the art will recognize that container 110 does not need to include handle 124.

Notably, while container 110 is illustrated in FIGS. 1 and 2 and described above as forming an enclosed chamber 111, one skilled in the art will recognize that container 110 is not limited to this form. Specifically, according to another example embodiment of the invention, container 110 may have no top wall 114 or only a partial top wall 114, for example, thereby forming an open dish, for example, that exposes chamber 111 and the massage oil therein. In this form, massage oil may be initially placed into chamber 111 through the exposed topside of the container and also dispensed through this exposed topside. Alternatively, the container may continue to have a spout, for example, for dispensing the massage oil. Furthermore, container 110 may also include a lid for covering the exposed topside of the container. In addition, container 110 may or may not include a handle when in this form. Notably, forming container 110 as an open dish may be preferable, for example, when the present invention is used for heating and dispensing thicker substances, such as body waxes.

Container 110 may be formed from any suitable material known in the art such as plastic, metal, glass, wood, etc. or some combination thereof. Container 110 may be rigid, thereby having a static form, or be elastically flexible, thereby allowing the container to be squeezed in order to assist with the dispensing of the massage oil, for example.

According to an example embodiment of the invention, one or more portions of container 110 are made of a heat conductive material. For example, as further described below, heating element 132 of base unit 130 may be situated along the bottom side of the base unit. In this configuration, when container 110 is placed into the base unit, heating element 132 and the outer surface, or a portion thereof, of bottom wall 112 of container 110 are adjacent one another and possibly in contact with one another. In order to transfer the heat more efficiently from heating element 132 to the massage oil, according to an example embodiment of the invention, bottom wall 112, or a portion thereof or an outer surface thereof, for example, is made of a heat conductive material. In this way, wall 112 readily conducts the heat from the heating element when placing container 110 into the base unit. As further described below, heating element 132 may alternatively or additionally by situated along other portions of base unit 130, such as the sides of the base unit. Accordingly, other portions of container 110, such as sidewall 116 or a portion thereof, for example, may also be made of a heat conductive material. In general, any suitable heat conductive material known in the art may be used. For example, the heat conductive material may be a metal, such as aluminum, iron, steel, copper, or an alloy thereof.

According to a further example embodiment of the invention, portions of container 110 beyond those areas that lie adjacent to heating element 132 when the container is placed into the base unit are also formed of a heat conductive material. In this way, the heat from heating element 132 disperses over larger areas of container 110, thereby more evenly heating the massage oil.

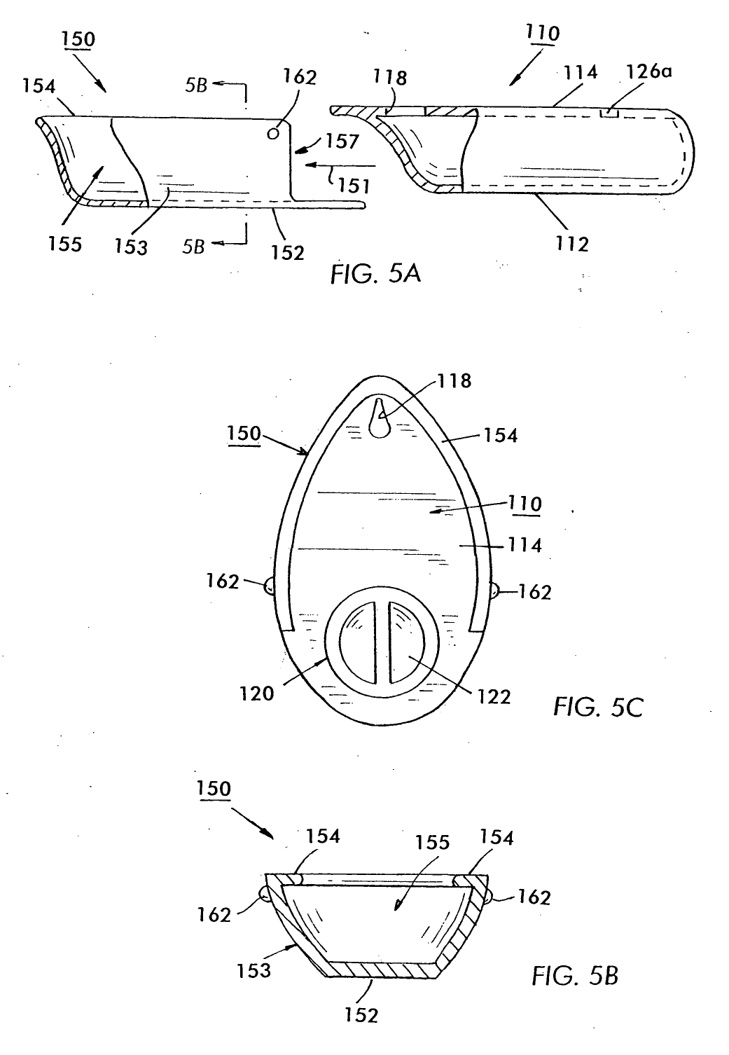

Referring now to base unit 130, according to an example embodiment of the invention and as illustrated in FIGS. 1, 3 and 4, this unit houses at least one heating element 132, as indicated above. (Note that while base unit 130 will be described as including a single heating element, the base unit may include more than one heating element.) In general, base unit 130 may have any suitable shape. As one example and as illustrated in FIGS. 1, 3 and 4, base unit 130 may include a bottom wall 142, a sidewall 144, and an open top-side 146, thereby forming an open chamber 148 shaped to readily receive container 110. In particular, chamber 148 may have a shape corresponding to the shape of container 110 along sidewall 116 and bottom wall 112. In this way, container 110 is placed into chamber 148 in order to heat the massage oil within chamber 111. As another example, base unit 130 may include, for example, only a bottom wall 142, thereby forming a platform on which container 110 is placed for heating.

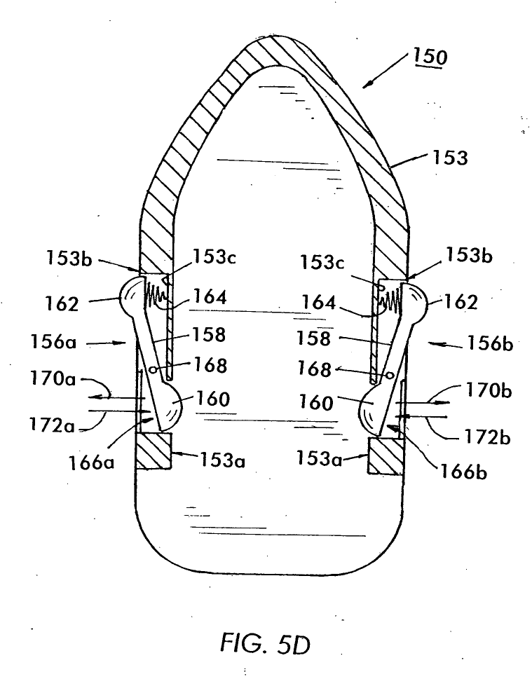

Notably, the outside of base unit 130 along bottom wall 142 may be flat, as illustrated in FIGS. 1 and 4, thereby allowing the base unit to be securely placed on a surface, such as a table, for example. Nonetheless, bottom wall 142 does not need to be flat and any mechanism known in the art for securely positioning the base unit on a surface may be used. In general, base unit 130 may be formed from any suitable material known in the art such as plastic, metal, wood, etc. or some combination thereof.

Heating element 132 may be a resistance-type electrical heating element as is known in the art, although any type of heating element may be used. Assuming heating element 132 is a resistance-type electrical heating element, base unit 130 may further include a power input mechanism in order to transfer power from a power source to the heating element. For example, standard electrical power from an outlet may power the heating element. In this case, base unit 130 may further include a standard power cord 134 in electrical connection with heating element 132. Alternatively, power from one or more batteries may power heating element 132. In this case, base unit 130 may further include a battery chamber in electrical connection with heating element 132 and for receiving one or more batteries. As a further alternative, base unit 130 may be configured to receive power from either an outlet or from batteries, as is readily known in the art, in which case base unit 130 may include both power cord 134 and a battery chamber. Nonetheless, heating element 132 may be powered from any suitable power source known in the art and base unit 130 may thereby include any suitable power input mechanism.

According to another example embodiment of the invention, base unit 130 may further include a commercially available thermostat 136, for example, in electrical connection with heating element 132. This thermostat may be selected and/or configured to maintain a pre-selected constant heating temperature for heating element 132, such as a temperature slightly above body temperature, thereby heating the massage oil within container 110 to this pre-selected temperature, for example. Alternatively, thermostat 136 may further include a thermostat control 136a that allows a user to adjust the operating temperature of thermostat 136 to a desired temperature, as is known in the art. Therrnostat control 136a may be a dial or multi-position switch, for example, that extends beyond sidewall 144, for example, and is thereby accessible to a user for manual adjustment. Thermostat control 136a may be a gradual type of control, for example, allowing a user to select one of many temperatures, or may be a definitive position type of control with two or more preset positions (e.g., low, medium, and high), for example, each corresponding to a predetermined temperature. Markings may be placed on sidewall 144 for example, and/or thermostat control 136a showing one or more possible settings for thermostat 136.

As illustrated in FIGS. 1, 3, and 4, heating element 132 may be positioned within chamber 148 along the inner surface of bottom wall 142 and may have a size/shape to substantially extend over the surface of the bottom wall, for example. According to another example embodiment of the invention, base unit 130 may also include a heat conductive plate 140 that is disposed over heating element 132 such that plate 140 contacts the heating element, for example. Alternatively, heating element 132 may be embedded within plate 140. Plate 140 may be made of metal, for example, such as aluminum, iron, steel, copper, or an alloy thereof. In this way, plate 140 conducts the heat from heating element 132 and assists in dispersing the heat. In this configuration, when container 110 is placed into base unit 130/chamber 148, bottom wall 112 of the container lies adjacent to plate 140/heating element 132, thereby heating the massage oil within container 110 from the bottom of the container.

Notably, base unit 130, plate 140, and container 110 may be formed such that the bottom wall 112 of the container rests upon and contacts plate 140 when the container is placed into the base unit/chamber 148. Alternatively, the base unit, plate, and container may be formed such that the bottom wall 112 of the container lies at a spaced distance above plate 140. For example, container 110 and base unit 130 may each include a lip around its upper edge such that the lip of container 110 rests upon the lip of base unit 130 when the container is inserted into the base unit. In this way, the container may suspend above plate 140.

In addition to plate 140 residing directly over heating element 132, as illustrated in FIGS. 1, 3, and 4, according to another example embodiment of the invention the plate may also extend beyond heating element 132 and along the inner surface of sidewall 144 of chamber 148, for example. In this way, plate 140 further disperses the heat from heating element 132. As such, when container 110 is placed into base unit 130 and into chamber 148, the sidewall 116 of container 110 also lies adjacent to plate 140, for example, thereby heating the massage oil from both the bottom and the sides of container 110.

Notably, a specific location and size of heating element 132 within chamber 148 is not required. For example, in addition to heating element 132 residing along bottom wall 142 of the base unit, it may also reside along the inner surface of sidewall 144 (alternatively, separate heating elements may reside along the bottom wall and sidewall, for example). Here, plate 140 may also extend along sidewall 144 and over the heating element. Again, in this configuration, container 110 is heated from both its bottom and sides. Alternatively, heating element 132 may only reside along the inner sidewall 144 and not along the inner bottom wall 142 of the base unit. Here, plate 140 may continue to extend along bottom wall 142, thereby dispersing heat to the bottom 112 of container 110. One skilled in the are will recognize that other configurations of heating element 132 and plate 140 are also possible.

In addition, one skilled in the art will also recognize that plate 140 is not required. Here, heating element 132 may be exposed when viewing chamber 148. In this configuration, container 110 may either contact the heating element when placed into the base unit/chamber 148 or may reside at a spaced distance above the heating element, as similarly described above.

As described above, according to an example embodiment of the invention, the bottom wall 112 and/or sidewall 116 of container 110, for example, or portions thereof, may be made of a heat conductive material, like metal, in order to transfer the heat more efficiently from the heating element to the massage oil. As can now be more readily understood, the bottom wall and sidewall of container 110 may be made of a heat conductive material along those portions that lie adjacent to plate 140 and/or heating element 132 when the container is inserted into base unit 130 and into chamber 148. Furthermore, additional portions of container 110, beyond those areas that lie adjacent to plate 140 and/or heating element 132, may also be formed of a heat conductive material in order to disperse the heat from the heating element over a larger area and thereby more evenly heating the massage oil.

According to an example embodiment of the invention, heating element 132 may automatically begin heating as soon as base unit 130 receives power through power cord 134 or from a battery, for example. Alternatively, base unit 130 may further include an on/off switch, such as a toggle switch (not shown in the Figures) or the like for example, that is in electrical connection with heating element 132 and that allows a user to manually turn the heating element on and off. Alternatively, this switch may be part of thermostat control 136a, for example.

According to another example embodiment of the invention, base unit 130 may include an on/off switch in the form of a pressure switch 138 that is in electrical connection with heating element 132. Pressure switch 138 is configured, for example, such that while pressure is applied to the switch, power is supplied to heating element 132 and such that when the pressure is removed from the switch, the power is shut-off from the heating element. Pressure switch 138 may be of any suitable type. For example, pressure switch 138 may simply be a button the pressing of which forms an electrical connection and the releasing of which breaks the electrical connection. Nonetheless, more complex types of “pressure” switches may be used.

According to a further example embodiment of the invention, pressure switch 138 is configured within base unit 130 such that when container 110 is inserted into the base unit and into chamber 148, the container causes pressure switch 138 to move to an on position (e.g., forms an electrical connection). Similarly, when container 110 is removed from the base unit, the container causes the pressure switch to move to an off position (e.g., breaks the electrical connection). For example, when inserting the container into the base unit, the container may either directly or indirectly contact and apply pressure to pressure switch 138. Similarly, the removing of the container would remove this applied pressure. As an example, pressure switch 138 may be situated within chamber 148 along plate 140 such that bottom wall 112 of container 110 applies pressure to the switch when the container is seated in base unit 130. Alternatively, pressure switch 138 may be situated along the inner sidewall 144 of base unit 130, for example, such that the sidewall 116 of container 110 applies pressure to the switch.

The present invention is not limited to a pressure on-off switch 138 as just described. Specifically, any switch known in the art that is configurable to move between on and off positions through the placing and removing of container 130 to and from base unit 130 can be used.

According to a further example embodiment of the invention, base unit 130 may include both a pressure switch 138 or the like, for example, and also an on/off switch, such as a toggle switch or a switch integral with thermostat control 136a. Here, pressure switch 138 may operate, for example, only when the on/off switch is in the on position. As another example, the on/off switch may allow the heating element to be turned on regardless of whether the pressure switch is in the on position.

As can be readily understood by one skilled in the art, through pressure switch 138 for example, when container 110 is placed into base unit 130, heating element 132 automatically turns on, thereby heating the massage oil within the container. Similarly, when container 110 is removed from base unit 130, heating element 132 automatically turns off. Advantageously, pressure switch 138 may improve power efficiency in that heating element 132 turns off when not in use. Such a mechanism is useful, for example, if batteries power the heating element. Pressure switch 138 is also convenient in that a user does not need to constantly turn the base unit on and off.

In an example of the use of massage oil heater 100 according to an example embodiment of the invention, a user of the massage oil heater removes cap 122, for example, from container 110, adds massage oil or the like to chamber 111, and thereafter replaces the cap. The user then places container 110 into base unit 130 in order to heat the massage oil and may also adjust thermostat control 136a to a desired setting. Assuming the base unit is receiving power through either power cord 134 or from a battery within a battery chamber, for example, upon placing the container into the base unit, pressure switch 138 moves to an on position, causing heating element 132 to automatically turn on and heat the massage oil. Once the massage oil is heated, the user removes container 110 from base unit 130, thereby causing the pressure switch to move to an off position and the heating element to turn off. The user may then grasp container 110 at handle 124 for example, and dispense massage oil from the container by tilting the container, for example, towards spout 118 so that oil pours from the spout. Between subsequent uses of container 110, the user may place the container back into base unit 130, causing pressure switch 138 to depress and heating element 132 to once again turn on, thereby keeping the massage oil at the desired temperature, for example. Alternatively, the user may place container 110 onto a surface, such as a table, for example.

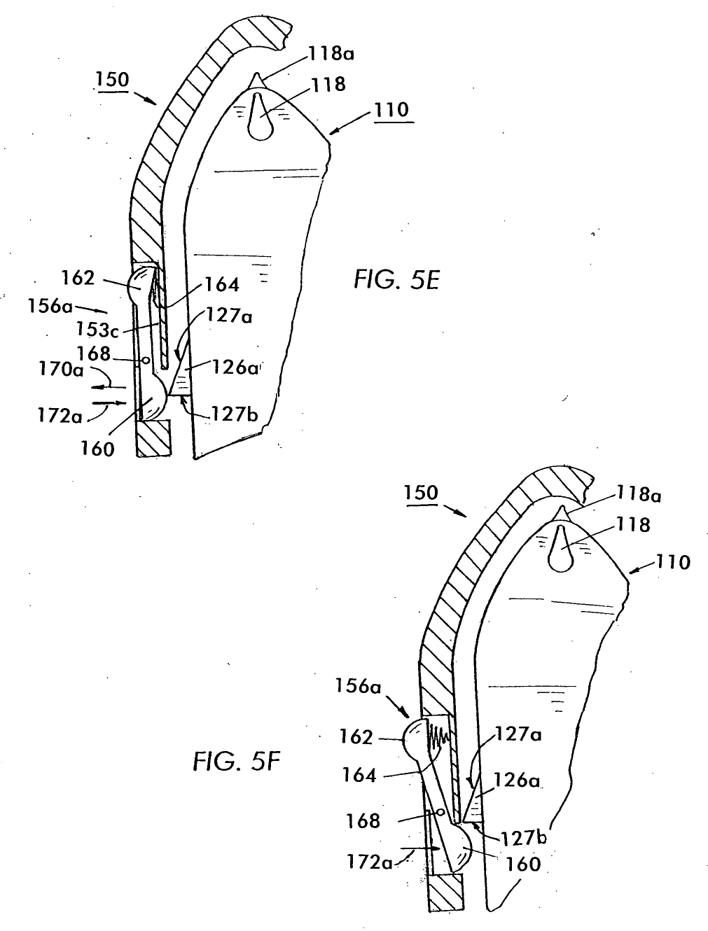

As just described, a user of massage oil heater 100 may grasp container 110 in order to dispense the massage oil therefrom and may also place container 110 onto a surface between uses, rather than placing container 110 back into base unit 130. Notably, container 110 may be fairly warm to the touch once the massage oil is heated. In addition, and as can be readily understood by one skilled in the art, once container 110 is removed from base unit 130, the heat from the massage oil may dissipate through the walls of the container. Referring now to FIGS. 5A-5C, according to a further example embodiment of the invention, massage oil heater 100 further includes a carrying glove 150. According to an example of the use of carrying glove 150, once the massage oil within container 110 is heated and the container is removed from base unit 130, the container is placed (or slid) into carrying glove 150, as illustrated by arrow 151 in FIG. 5A, such that glove 150 covers one or more surfaces/walls of container 110. According to one aspect of the present invention, carrying glove 150 acts as a heat buffer, allowing a user to easily grasp container 110 without being affected by the heat of the container. According to another aspect of the present invention, carrying glove 150 alternatively or additionally also acts as an insulation layer for container 110, trapping the heat within the container and helping to keep the massage oil warm. When the massage oil within container 110 needs to be reheated, such as when additional oil is added to the container, carrying glove 150 is removed from the container, for example, and the container is placed into base unit 130, as described above.

In general, carrying glove 150 can be formed from any suitable material known in the art that will buffer heat from a user's touch and/or that will trap heat dissipating from container 110 once the container is inserted into the glove. Accordingly, carrying glove 150 may be formed from any non-heat-conductive material known in the art. In general, carrying glove 150 may be formed from a flexible material, such as cloth, fabric, or leather, or may be formed from a flexible material lined with a non-heat-conductive material, for example. Alternatively, carrying glove 150 may be formed, for example, from a rigid material, such as plastic, or from a non-heat conductive material sandwiched between two materials like plastic, etc.

In general, carrying glove 150 preferably has a size and shape such that the glove covers one or more sides/walls of container 110. Nonetheless, carrying glove 150 may have any suitable shape. Notably, however, if container 110 has one or more portions/surfaces made of a heat conductive material, as described above, carrying glove 150 preferably has a size and shape to cover these surfaces. In this way, carrying glove 150 protects a user from these surfaces and/or traps any heat that may dissipate through these surfaces once container 110 is removed from the base unit.

As illustrated in FIGS. 5A-5C, carrying glove 150 may include, for example, a bottom wall 152, a partial sidewall 153, and a lip 154 surrounding the upper region of sidewall 153, thereby forming an open void 155 shaped to readily receive container 110. In particular, void 155 may have a shape corresponding to the sidewall 116 and bottom wall 112 of container 110. As illustrated in FIGS. 5A and 5B, the outer surface of bottom wall 152 of carrying glove 150 may be flat so that when the glove has a container 110 therein, the glove can be securely placed on a surface, such as a table, for example. Nonetheless, bottom wall 152 does not need to be flat and any mechanism known in the art for securely positioning the carrying glove on a surface may be used.

As further illustrated in FIG. 5A, sidewall 153 of example carrying glove 150 may only extend partially around bottom wall 152, thereby providing an opening 157 through which container 110 can be inserted into and removed from carrying glove 150. Specifically, as illustrated in FIGS. 5A and 5C, to insert container 110 into example carrying glove 150, container 110 is slid, spout first, through opening 157 such that bottom wall 112 of the container is adjacent to bottom wall 152 of the glove and such that lip 154 of the glove extends over the top side 114 of the container. In this way, opening 120, cap 122, and spout 118 of container 110, for example, are readily accessible from the topside of the glove, as illustrated in FIG. 5C. Container 110 is removed from example carrying glove 150 in a similar, but opposite fashion.

Notably, lip 154 of example carrying glove 150 assists in retaining container 110 within the glove. Alternatively or in addition to lip 154, according to an example embodiment of the invention the glove and/or container may include a locking mechanism to retain container 110 within carrying glove 150. For example, assuming glove 150 is made of a rigid material, such as plastic, glove 150 may include a pair of locking arms 156a and 156b (see FIGS. 5D, 5E, and 5F) along opposing sides of sidewall 153 and container 110 may include a pair of locking wedges 126a and 126b along opposing sides of sidewall 116 (see FIG. 2). Each locking arm 156a and 156b interlocks with a corresponding locking wedge 126a and 126b, thereby preventing container 110 from sliding out of glove 150.

Referring to FIG. 5D (note that lip 154 is cut away in this Figure to expose locking arms 156a and 156b), example locking arms 156a and 156b each includes, for example, an arm 158 with a locking tab 160 at one end and a release button 162 and spring 164 at the other end. To connect the locking arms to carrying glove 150, the carrying glove may include, for example, a pair of voids 166a and 166b formed along opposing sides of sidewall 153. Each locking arm 156a and 156b is positioned horizontally within a corresponding void 166a and 166b and is attached to sidewall 153 by a fulcrum 168, for example. Fulcrum 168 is positioned along arm 158 thereby allowing release button 162/spring 164 and locking tab 160 to swivel. As illustrated in FIG. 5D, the locking tab 160 and the release button 162 extend beyond the inner wall 153a and outer wall 153b, respectively, of sidewall 153. Spring 164 is positioned between release button 162 and an inner surface 153c of void 166a/166b. In this configuration, when release button 162 for each of the locking arms 156a and 156b is pressed, spring 164 presses against inner surface 153c and compresses, causing locking tab 160 to move in direction 170a and 170b, respectively. Similarly, when release button 162 is released for each of the locking arms 156a and 156b, spring 164 expands, causing locking tab 160 to move in direction 172a and 172b, respectively

Referring to FIG. 5E, which illustrates an example interaction between locking arm 156a and locking wedge 126a (note that lip 154 is cut away in this Figure to expose locking arm 156a), as container 110 is inserted into carrying glove 150 in direction 151, locking tab 160 contacts side 127a of wedge 126a, which pushes the locking tab in direction 170a, causing spring 164 to compress against inner surface 153c (note that locking arm 156b and locking wedge 126b similarly operate). As container 110 is inserted further into glove 150, wedge 126a eventually passes locking tab 160, thereby allowing spring 164 to expand and move locking tab 160 of locking arm 156a back in direction 172a. As illustrated in FIGS. 5F, as locking tab 160 moves back in direction 172a, it interlocks with side 127b of wedge 126a. In this way, locking wedges 126a and 126b and locking arms 156a and 156b prevent container 110 from sliding out of carrying glove 150 through opening 157.

Similarly, to later remove container 110 from carrying glove 150, each release button 162 of locking arms 156a and 156b is pressed, for example, causing the springs 164 to compress and the locking tabs 160 to move in directions 170a and 170b, the locking tabs thereby clearing side 127b of wedges 126a and 126b. Once the locking tabs are clear of the wedges, container 110 can be slid out of the glove 150.

As indicated above, carrying glove 150 may have any suitable size and shape and in particular, one skilled in the art will recognize that glove 150 is not limited to the size/shape as illustrated in FIGS. 5A-5F. For example, carrying glove 150 may have a complete top wall with openings formed therein for spout 118 and opening 120/lid 122. Similarly, the sidewall 153 of carrying glove 150 may extend completely around the perimeter of bottom wall 152, thereby covering sidewall 116 of container 110 when the container is inserted into the glove.

In addition, the use of a lip 154 and/or complimentary locking mechanisms, such as locking arms 156a/156b and locking wedges 126a /126b, to retain the container within the carrying glove is not required and any mechanism known in the art for retaining container 110 within carrying glove 150 can be used. For example, carrying glove 150 may include one or more straps that extend over top wall 114 and/or sidewall 116 of container 110 when the container is inserted into the glove.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

1. A system for heating a substance to be applied to a human body, said system comprising:
a container for holding the substance to be heated;
a base unit separate from the container;
at least one heating element connected to said base unit; and
an on-off switch in electrical connection with said at least one heating element;
wherein said base unit is configured to receive said container and to heat the substance therein through said at least one heating element, wherein said at least one heating element is configured to heat the substance in said container to substantially body temperature, such that the substance is safe for application to skin of a human body, and wherein said switch is configured such that when said base unit receives said container, said container causes said switch to move to an on position, thereby turning on said at least one heating element.

2. The system of claim 1, wherein said switch is further configured such that when said container is removed from said base unit, said container causes said switch to move to an off position, thereby turning off said at least one heating element.

3. The system of claim 2, wherein said switch is a pressure on-off switch configured such that when said base unit receives said container, said container applies a pressure to said pressure switch thereby moving said pressure switch to said on position, and wherein when said container is removed from said base unit, said container removes the pressure from said pressure switch thereby moving said pressure switch to said off position.

4. The system of claim 1, wherein the substance is massage oil.

5. The system of claim 1, wherein said container comprises a spout for dispensing the substance.

6. The system of claim 1, wherein said container comprises one or more metal surfaces to assist with the heating of the substance within said container.

7. The system of claim 6, wherein when said base unit receives said container, at least one of said one or more metal surfaces of said container lies adjacent to at least one of said at least one heating element.

8. The system of claim 1, further comprising a thermostat in connection with said at least one heating element.

9. The system of claim 8, further comprising a thermostat control connected to said thermostat and operable to configure an operating temperature of said thermostat.

10. The system of claim 1, further comprising at least one power input mechanism configured to transfer power from a power source to said at least one heating element.

11. The system of claim 1, further comprising a glove that is configured to receive said container such that said glove covers one or more surfaces of said container.

12. The system of claim 11, wherein said glove comprises one or more materials that retain heat within said container when said glove receives said container.

13. The system of claim 11, wherein said glove comprises a locking mechanism for retaining said container within said glove.

14. The system of claim 11, wherein said container comprises one or more metal surfaces and wherein said glove covers at least one of said one or more metal surfaces when receiving said container.

15. The system of claim 3, further comprising a glove that is configured to receive said container such that said glove covers one or more surfaces of said container.

16. The system of claim 1, further comprising a heat conductive plate in contact with at least one of said at least one heating element and for dispersing heat.

17. A system for heating a substance to be applied to a human body, said system comprising:
a container for holding the substance to be heated, said container comprising one or more surfaces;
a base unit separate from said container;
at least one heating element connected to said base unit, wherein said base unit is configured to receive said container and to heat the substance therein through said at least one heating element, the heating element configured to heat the substance to substantially body temperature such that the substance is safe for application to skin of a human being; and
a glove separate from said base unit and configured to detachably receive said container such that said glove covers at least one of said one or more container surfaces.

18. The system of claim 17, wherein the substance is massage oil.

19. The system of claim 17, wherein said container comprises a spout for dispensing the substance.

20. The system of claim 17, wherein at least one of said one or more container surfaces is made of metal to assist with the heating of the substance within said container.

21. The system of claim 20, wherein when said base unit receives said container, said at least one metal surface of said container lies adjacent to at least one of said at least one heating element.

22. The system of claim 20, wherein when said glove receives said container, said glove covers said at least one metal surface of said container.

23. The system of claim 17, further comprising a thermostat in connection with said at least one heating element.

24. The system of claim 17, further comprising at least one power input mechanism configured to transfer power from a power source to said at least one heating element.

25. The system of claim 17, wherein said glove comprises one or more materials that retain heat within said container when said glove receives said container.

26. The system of claim 17, wherein said glove comprises a locking mechanism for retaining said container within said carrying glove.

27. The system of claim 17, further comprising a heat conductive plate in contact with at least one of said at least one heating element and for dispersing heat.

28. A method for heating a substance to be applied to a human body, said method comprising the steps of:
adding the substance to a container;
placing said container on a base unit comprising at least one heating element such that said container causes an on-off switch in electrical connection with said at least one heating element to move to an on position, thereby turning on said at least one heating element;
heating the substance through said at least one heating element to substantially body temperature;
dispensing the heated substance from said container; and
applying the heated substance to skin of the human body.

29. The method of claim 28, further comprising, prior to said dispensing step, the step of removing said container from said base unit such that said container causes said switch to move to an off position, thereby turning off said at least one heating element.

30. The method of claim 29, wherein said switch is a pressure on-off switch, wherein said placing step causes said container to apply a pressures to said pressure switch thereby moving said pressure switch to said on position, and wherein said removing step causes said container to remove the pressure applied to said pressure switch thereby moving said pressure switch to said off position.

31. The method of claim 29, wherein said dispensing step comprises the step of pouring the heated substance through a spout connected to said container.

32. The method of claim 28, wherein said container comprises one or more metal surfaces, and wherein said placing step causes at least one of said one or more metal surfaces to lie adjacent to at least one of said at least one heating element.

33. The method of claim 29, further comprising prior to said dispensing step the step of inserting said container into a glove such that said glove covers one or more surfaces of said container.

34. The method of claim 33, further comprising after said applying step the steps of:
removing said container from said glove; and
placing said container on said base unit to heat the substance in the container.

35. The method of claim 34, wherein said step of removing said container from said glove comprises the step of manipulating a locking mechanism on said glove in order to release said container from said glove.

36. The method of claim 30, further comprising prior to said dispensing step the step of inserting said container into a glove such that said glove covers one or more surfaces of said container.

37. The method of claim 28, further comprising the step of adjusting a thermostat in connection with said heating element to a desired temperature setting.

38. The system of claim 1, wherein said base unit includes a sidewall that forms a chamber therein, and wherein said chamber is configured to receive said container such that said sidewall of said base unit extends substantially along a sidewall of said container.

39. The system of claim 11, wherein said glove and said container each include a locking mechanism that mechanically interact to retain said container within said glove.

40. The system of claim 11, wherein said glove is formed of a substantially rigid material.

41. The system of claim 17, wherein said base unit includes a sidewall that forms a chamber therein, and wherein said chamber is configured to receive said container such that said sidewall of said base unit extends substantially along a sidewall of said container.

42. (Canceled)

43. The system of claim 17, wherein said glove and said container each include a locking mechanism that mechanically interact to retain said container within said glove.

44. The system of claim 17, wherein said glove is formed of a substantially rigid material.
